(19) United States
(12) Patent Application Publication
(10) Pub. No.: US 2025/0071673 A1
(43) Pub. Date: Feb. 27, 2025

(54) CELLULAR WIRELESS NETWORK CHARACTERIZATION AND SELECTION BASED ON WIRELESS DEVICE USAGE

(71) Applicant: Apple Inc., Cupertino, CA (US)

(72) Inventors: Raj S. CHAUGULE, San Jose, CA (US); Gencer CILI, Santa Clara, CA (US); Sai Raj KARRA, San Jose, CA (US)

(21) Appl. No.: 18/738,483

(22) Filed: Jun. 10, 2024

Related U.S. Application Data
(60) Provisional application No. 63/520,910, filed on Aug. 21, 2023.

(51) Int. Cl. H04W 48/18; H04W 8/18; H04W 84/04

(52) U.S. Cl. CPC H04W 48/18; H04W 8/183; H04W 84/042

(57) ABSTRACT

This application sets forth techniques for cellular wireless network characterization and selection based on wireless device usage, including selection of a public land mobile network (PLMN) and/or a subscriber identity module (SIM) best matched to PLMN characterized performance scores and/or habitual device usage of a wireless device. Network performance scores for multiple PLMNs based on crowd-sourced information are downloaded to a wireless device. The wireless device determines a best match between characterized network performance scores to habitual device usage characterization of the wireless device. A best matched roaming PLMN can be determined for a single SIM wireless device. A best matched SIM paired with a best matched PLMN can be chosen as a primary SIM to optimize roaming performance of a multiple SIM wireless device. Additionally, a SIM, associated with a best matched PLMN, can be recommended for installation to a multiple SIM capable wireless device.

### CROSS-REFERENCE TO RELATED APPLICATIONS

The present application claims the benefit of U.S. Provisional Application No. 63/520,910, entitled “CELLULAR WIRELESS NETWORK CHARACTERIZATION AND SELECTION BASED ON WIRELESS DEVICE USAGE,” filed Aug. 21, 2023, the content of which is incorporated by reference herein in its entirety for all purposes.

### FIELD

The described embodiments set forth techniques for cellular wireless network characterization and selection based on wireless device usage, including selection of a public land mobile network (PLMN) and/or a subscriber identity module (SIM) best matched to habitual device usage of a wireless device.

### BACKGROUND

Many wireless devices are configured to use removable Universal Integrated Circuit Cards (UICCs) that enable the wireless devices to access services provided by Mobile Network Operators (MNOs). In particular, each UICC includes at least a microprocessor and a read-only memory (ROM), where the ROM is configured to store an MNO profile that the wireless device can use to register and interact with an MNO to obtain wireless services via a cellular wireless network. A profile may also be referred to as subscriber identity module (SIM). Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The CUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. More recently, integrated SIMs (iSIMs) have been proposed as a type of SIM that integrates directly into device hardware, e.g., a device processor and/or attached memory and/or a system on a chip (SoC) component, without use of a separate eUICC to store the iSIM.

Wireless devices that support downloadable eSIMs and/or iSIMs, referred to herein generically as SIMs, provide for customization of cellular wireless service usage; however, users presently perceive use of such SIMs as inconvenient or difficult to use compared with replacing a physical SIM card in a wireless device. Some wireless devices, however, do not support use of physical SIM cards. A user may be unable to determine a suitable downloadable SIM for use on a wireless device, where different users can have substantially different usage requirements. There exists a need to facilitate recommendation, selection, and/or installation of SIMs for access to cellular wireless service matched to user-specific usage of the wireless device.

### SUMMARY

This Application sets forth techniques for cellular wireless network characterization and selection based on wireless device usage, including selection of a public land mobile network (PLMN) and/or a subscriber identity module (SIM) best matched to habitual device usage of a wireless device. Cellular wireless network performance scores for multiple PLMNs based on crowd-sourced information collected from multiple wireless devices by a performance service server are downloaded to a wireless device. PLMNs are characterized based on multiple performance metrics including one or more or: i) a data transfer score for downlink and uplink throughput rates, ii) a latency score for measured data transfer delays, iii) a video calling score characterizing setup success and call drop ratios, iv) a voice telephony score based on call setup success and call drop ratios, call setup time and packet loss rate, v) a network access score based on accessibility and retention to a cellular wireless access network, or vi) a network configuration score based on power saving network configuration parameters. Habitual device usage of the wireless device is characterized based on multiple metrics including one or more of: i) data intensive activity metric; ii) a latency critical activity metric, iii) a video calling activity metric, iv) a cellular voice activity metric, v) a burst connection activity metric, or vi) a low power mode metric. The wireless device determines a best match between characterized network performance across multiple metrics to the habitual device usage characterization of the wireless device. For a wireless device with a single SIM installed, a best matched roaming PLMN can be determined for the single SIM, where the best matched roaming PLMN may differ from an operator preferred PLMN list associated with the single SIM. For a wireless device with multiple SIMs installed, a best home SIM associated with a best matched roaming PLMN for a region visited by the wireless device can be chosen as a primary SIM to optimize roaming performance. For a wireless device configurable to include multiple SIMs, a local SIM, available for installation to the wireless device and associated with a best matched roaming PLMN, can be determined and recommended for downloading and installation. Local SIMs matched to device usage for the wireless device can be proactively recommended based on detection that the wireless device is roaming in or likely to roam to a visited region, e.g., based on knowledge of past device usage behavior, user input, network provided information, etc. When a recommended local SIM is not selected or installed, a best matched home SIM and associated PLMN can be selected for active use by the wireless device. SIMs can include electronic SIMs (eSIMs) and/or integrated SIMs (iSIMs) depending on the applicable configuration of the wireless device.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates a block diagram of an exemplary system for public land mobile network (PLMN) selection and/or subscriber identity module (SIM) selection for a wireless device, according to some embodiments.

FIG. 4A illustrates a diagram of exemplary PLMN selection for a single SIM wireless device, according to some embodiments.

FIG. 4B illustrates a diagram of exemplary PLMN and SIM selection for a multiple SIM wireless device, according to some embodiments.

FIG. 4C illustrates a diagram of exemplary PLMN and SIM selection including recommended local SIM installation for a multiple SIM capable wireless device, according to some embodiments.

FIG. 5 illustrates a flowchart of an exemplary PLMN recommendation state machine for a wireless device, according to some embodiments.

FIGS. 6A and 6B illustrate exemplary user interface (UI) displays for recommending SIMs for a wireless device, according to some embodiments.

FIG. 7A illustrates a table of exemplary PLMN characterization metrics, according to some embodiments.

FIG. 7B illustrates tables of an example of performance scoring PLMNs based on PLMN characterization metrics and habitual device usage for a wireless device, according to some embodiments.

FIG. 8A illustrates a flowchart of an example of determining a PLMN recommendation for a single SIM wireless device, according to some embodiments.

FIG. 8B illustrates a flowchart of an example of selecting a PLMN/SIM pair for a multiple SIM wireless device, according to some embodiments.

FIGS. 8C and 8D illustrate flowcharts of an example of determining a recommended PLMN and SIM pair for a multiple SIM capable wireless device, according to some embodiments.

FIGS. 9A, 9B, and 9C illustrate flowcharts of exemplary methods performed by a wireless device to determine a SIM and/or a PLMN matched to device usage of the wireless device, according to some embodiments.

FIG. 10 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application sets forth techniques cellular wireless network characterization and selection based on wireless device usage, including selection of a public land mobile network (PLMN) and/or a subscriber identity module (SIM) best matched to habitual device usage of a wireless device. Cellular wireless network performance scores for multiple PLMNs based on crowd-sourced information collected from multiple wireless devices by a performance service server are downloaded to a wireless device. Updated PLMN network performance scores can be obtained by the wireless device, e.g., periodically, on demand, or responsive to a push notification indicating their availability. PLMNs are characterized based on multiple performance metrics including one or more or: i) a data transfer score for downlink and uplink throughput rates, ii) a latency score for measured data transfer delays, iii) a video calling score characterizing setup success and call drop ratios, iv) a voice telephony score based on call setup success and call drop ratios, call setup time and packet loss rate, v) a network access score based on accessibility and retention to a cellular wireless access network, or vi) a network configuration score based on power saving network configuration parameters. PLMN characterization can be based on anonymized privacy-preserving information regarding cellular wireless network performance determined by wireless devices associated with a device manufacturer and agglomerated by a performance service server managed by the device manufacturer or a designee thereof. Habitual device usage of the wireless device is characterized based on multiple metrics including one or more of: i) data intensive activity metric; ii) a latency critical activity metric, iii) a video calling activity metric, iv) a cellular voice activity metric, v) a burst connection activity metric, or vi) a low power mode metric.

Device usage characteristics for the wireless device can be stored locally on the wireless device to preserve user privacy. The network performance scores and the device usage metrics can be used to determine a best match (e.g., most similar in an n-dimensional vector space) of one or more PLMNs to the specific habitual device usage characterization of the wireless device. Device usage metrics for the wireless device can be normalized to a fixed range of values, e.g., between 0 and 1. Similarly, network performance scores can be normalized to the same fixed range of values, e.g., between 0 and 1. An n-dimensional vector of the normalized network performance scores can be compared to a corresponding n-dimensional vector of the normalized habitual device usage metrics to determine a similarity metric indicating how well matched cellular wireless performance of a PLMN is to device-specific usage of a particular wireless device. Multiple PLMNs can be compared to the device usage characteristics for the wireless device and ranked based on computed similarity metrics. One or more highest-ranked PLMNs available within a region in which the wireless device operates can be determined in order to determine one or more of: a visited PLMN (VPLMN) to use by a single SIM wireless device, a SIM and PLMN combination to use for a multiple SIM wireless device, or a local SIM (and PLMN) to recommend for installation to a multiple SIM capable wireless device.

For a wireless device with a single SIM installed, a best matched roaming PLMN can be determined for the single SIM, where the best matched roaming PLMN may differ from an operator preferred PLMN list associated with the single SIM. For a wireless device with multiple SIMs installed, a best home SIM associated with a best matched roaming PLMN for a region visited by the wireless device can be chosen as a primary SIM to optimize roaming performance. For a wireless device configurable to include multiple SIMs, a local SIM, available for installation to the wireless device and associated with a best matched roaming PLMN, can be determined and recommended for downloading and installation. Local SIMs matched to device usage for the wireless device can be proactively recommended based on detection that the wireless device is roaming in or likely to roam to a visited region, e.g., based on knowledge of past device usage behavior, user input, network provided information, etc., When a recommended local SIM is not selected or installed, a best matched home SIM and associated PLMN can be selected for active use by the wireless device. SIMs can include electronic SIMs (eSIMs) and/or integrated SIMs (iSIMs) depending on the applicable configuration of the wireless device.

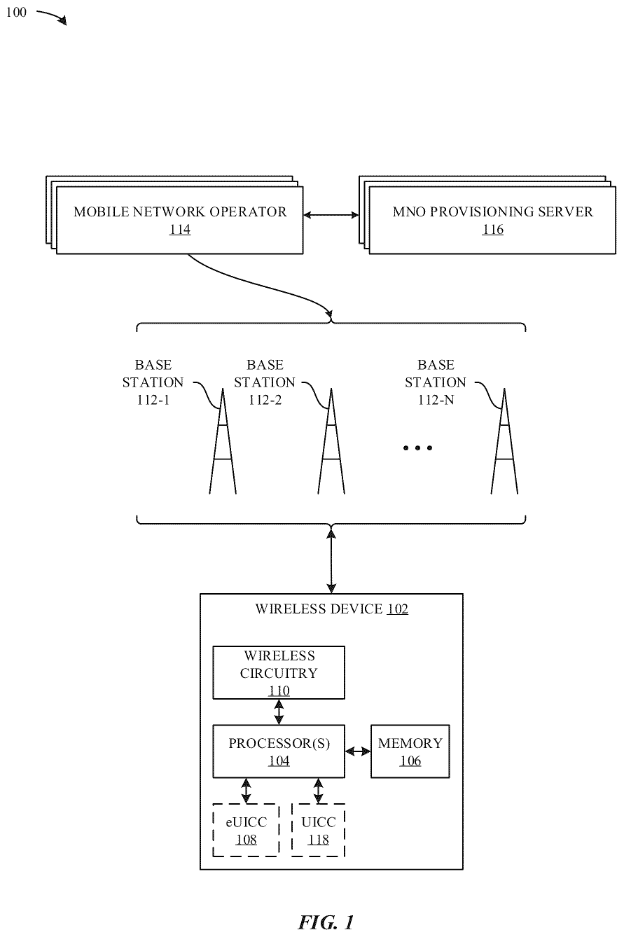

These and other embodiments are discussed below with reference to FIGS. 1-10; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a mobile wireless device, a mobile device, a user equipment (UE) and the like, a group of base stations 112-1 to 112-N that are managed by different Mobile Network Operators (MNOs) 114, and a set of MNO provisioning servers 116 that are in communication with the MNOs 114. Additional MNO infrastructure servers, such as used for account management and billing are not shown. The wireless device 102 can represent a cellular-capable computing device (e.g., an iPhone® or an iPad® by Apple®) or a cellular-capable wearable device (e.g., an Apple Watch), the base stations 112-1 to 112-N can represent cellular wireless network entities, including evolved NodeBs (eNodeBs or eNBs) for fourth generation (4G) long term evolution (LTE) wireless networks and/or next generation NodeBs (gNodeBs or gNB) for fifth generation (5G) wireless networks (or comparable nodes for future generation wireless networks), where the cellular wireless network entities are configured to communicate with the wireless device 102, and the MNOs 114 can represent different wireless service providers that provide specific cellular wireless services (e.g., voice and data) to which the wireless device 102 can subscribe, such as via a cellular wireless service subscription account for a user of the wireless device 102.

As shown in FIG. 1, the wireless device 102 can include processing circuitry, which can include one or more processor(s) 104 and a memory 106, and wireless circuitry 110 used for transmission and reception of cellular wireless radio frequency signals. The wireless circuitry 110 can include analog hardware components, such as antennas and amplifiers, as well as digital processing components, such as signal processors (and/or general/limited purpose processors) and associated memory. In some embodiments, the wireless device 102 includes an embedded universal integrated circuit card (eUICC) 108 for storing one or more electronic SIMs (eSIMs). In some embodiments, the wireless device 102 includes (or is capable of including) one or more integrated SIMs (iSIMs) stored securely in hardware of the wireless device 102, e.g., in a processor (104), in memory (106), or in a system on a chip (SoC) component. In some embodiments, the wireless device 102 includes one or more physical UICCs 118, also referred to as Subscriber Identity Module (SIM) cards, in addition to or substituting for one or more eSIMs on the eUICC 108 or one or more iSIMs stored in hardware of the wireless device 102. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through a base station 112 (or via multiple base stations 112), such as one or more of the base stations 112-1 to 112-N illustrated. For example, the eUICC 108 can be configured to store and manage one or more eSIMs for one or more MNOs 114 for different cellular wireless service subscriptions to which the mobile wireless device 102 is subscribed. To be able to access cellular wireless services provided by an MNO 114, can be eSIM reserved for download and installation to the eUICC 108. The eUICC 108 can store one or more eSIMs obtained from one or more associated MNO provisioning servers 116. An MNO provisioning server 116 can be maintained by a manufacturer of the wireless device 102, by an MNO 114, by a third party entity, or the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel. Similarly, one or more iSIMs can be stored securely in hardware of the wireless device 102 to enable access to cellular wireless services. Selection and/or recommendation of eSIMs and/or iSIMs, both of which will be generically referred to herein as SIMs, for a wireless device 102 to use based on crowd-sourced performance characterization of public land mobile networks (PLMNs) and habitual usage behavior of the wireless device can be performed locally at the wireless device 102 preserving a user's device usage privacy, while matching use of the wireless device 102 across multiple metrics to a best available PLMN. In some cases, a new local SIM (eSIM or iSIM) can be recommended to, selected by, and/or installed in the wireless device 102 to provide optimized cellular wireless performance well-matched to habitual usage of the wireless device 102.

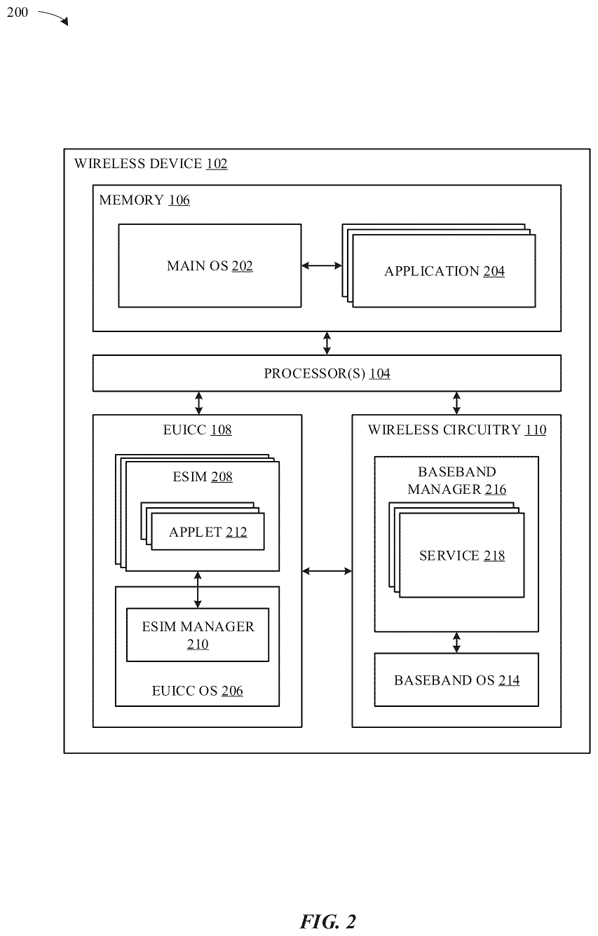

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing wireless circuitry 110 with access to the eSIMs 208 to provide access to cellular wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the wireless circuitry 110 of the mobile wireless device 102 can include a baseband OS 214 that is configured to manage hardware resources of the wireless circuitry 110 (e.g., a processor, a memory, different radio components, etc.). According to some embodiments, the wireless circuitry 110 can implement a baseband manager 216 that is configured to interface with the eUICC 108 to establish a secure channel with an MNO provisioning server 116 and obtaining information (such as eSIM/iSIM data) from the MNO provisioning server 116 for purposes of managing eSIMs 208 and/or iSIMs. The baseband manager 216 can be configured to implement services 218, which represents a collection of software modules that are instantiated by way of the various applets 212 of enabled eSIMs 208 that are included in the eUICC 108 and/or iSIMs in the wireless device 102. For example, services 218 can be configured to manage different connections between the wireless device 102 and MNOs 114 according to the different eSIMs 208 that are enabled within the eUICC 108 (and/or different iSIMs enabled in hardware of the wireless device 102). For one or more iSIMs embedded directly in hardware of the wireless device 102, e.g., in a processor 104, memory 106, or an SoC (not shown), the one or more iSIMs can contain modules that provide similar functionality as those illustrated for eSIMs 208, and supporting eSIM software/firmware, such as the eSIM manager 210 and eUICC OS 206, can be provided by similar software/firmware elements in the hardware of the wireless device 102 in which the one or more iSIMs are stored.

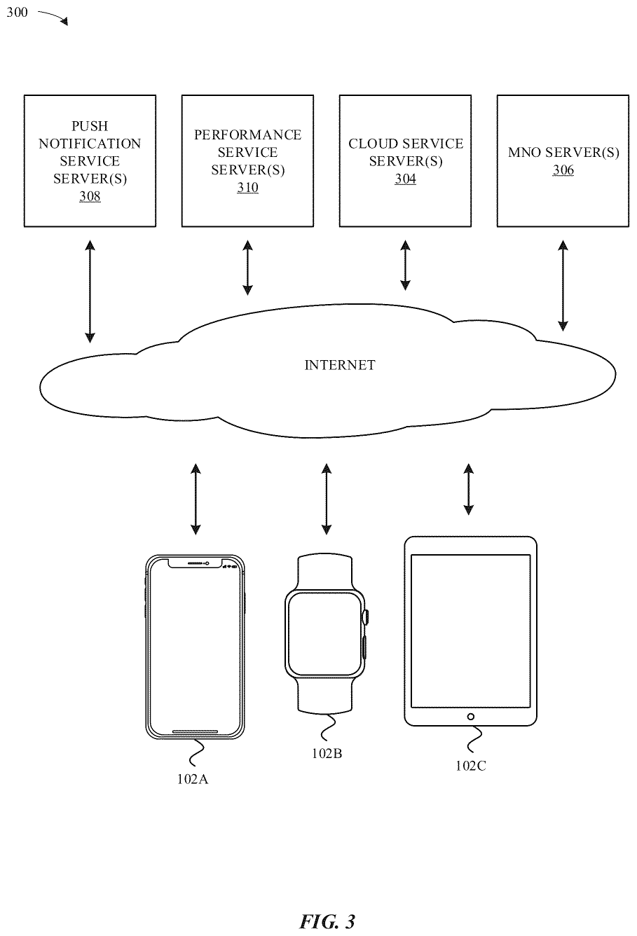

FIG. 3 illustrates a diagram 300 of an exemplary system that can include any combination of different types of wireless devices 102 that can support cellular wireless connectivity with support from various network-based servers to provide SIM and/or PLMN recommendations for access to cellular wireless services for a wireless device 102. Different types of wireless devices 102 can include a mobile phone 102A, a cellular-capable wearable device 102B, and a cellular-capable tablet computer 102C. Cellular capability for the wireless devices 102A-102C can be based on SIM cards (UICCs 118), eSIMs 208 included on eUICCs 108, and/or on iSIMs.

In some cases, the wireless devices 102A, 102B, 102C can each be associated with a common user account, e.g., a cloud-based service account, such as an iCloud® account that is network accessible to the wireless devices 102 via Internet data connections to one or more cloud service servers 304. Data for a wireless device 102A, 102B, 102C can be stored securely in the cloud-based service account on one or more cloud service servers 304, which in some cases can be used to transfer information between different wireless devices 102. For example, a use can replace an older wireless device 102 with a newer wireless device 102 and seek to transfer various information, settings, preferences and the like from the older wireless device 102 to the newer wireless device 102. Additionally, habitual device usage characteristics collated and determined by the older wireless device 102 can be transferred to the newer wireless device 102, either directly in a peer-to-peer transfer or via backup and restore through local storage or via remote storage on the one or more cloud service servers 304. The habitual device usage characteristics can be encrypted before transfer via remote storage to preserve user privacy before loading to the newer wireless device 102.

An MNO 114 can provide cellular wireless services to the set of wireless devices 102 and can manage access to cellular wireless networks to access the cellular wireless services offered by the MNO 114 for a particular cellular wireless service subscription (or for a set of cellular wireless service subscriptions) via one or more MNO servers 306. The MNO servers 306 can include one or more provisioning servers 116 for providing eSIMs 208 (and/or iSIMs) to wireless devices 102. A SIM (e.g., eSIM 208 and/or iSIM) can be determined and recommended for download and installation to a wireless device 102 based on matching cellular wireless network performance scores for various network metrics to habitual device usage of the wireless device 102 based on multiple device metrics. Cellular wireless network performance scores can be maintained at one or more performance service servers 310, which can accumulate performance metrics, which can be anonymized, measured by multiple wireless devices 102. The one or more performance service servers can determine normalized performance scores for various cellular wireless networks worldwide and provide the performance scores to wireless devices 102 periodically or on demand. The wireless device 102 can register to receive push notifications, e.g., from one or more push notification service servers 308, when updated performance scores for one or more cellular wireless networks are available for the wireless device 102. In some cases, responsive to selection and consent of a user of the wireless device 102, one or more SIMs can be downloaded from an MNO server 306, such as a provisioning server 116, and installed on the wireless device 102.

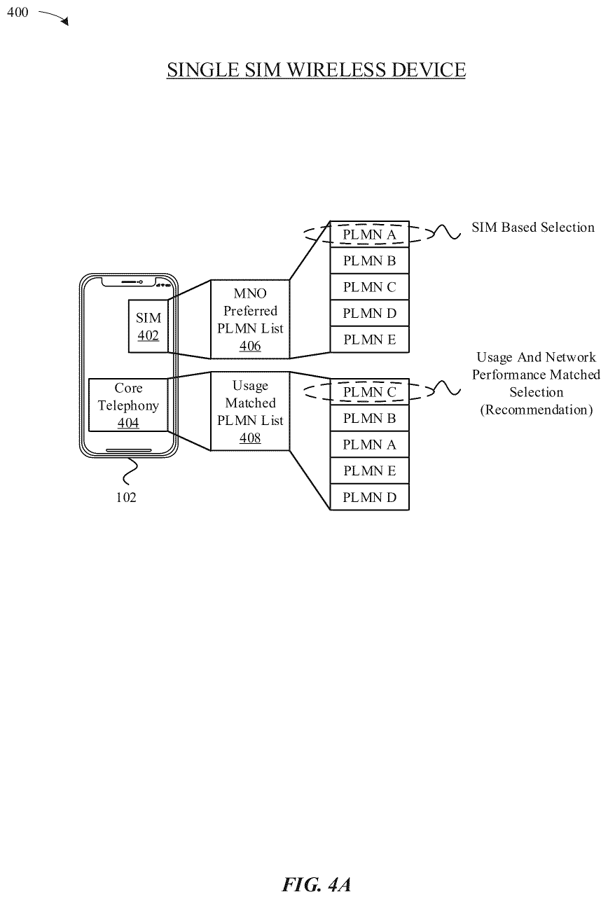

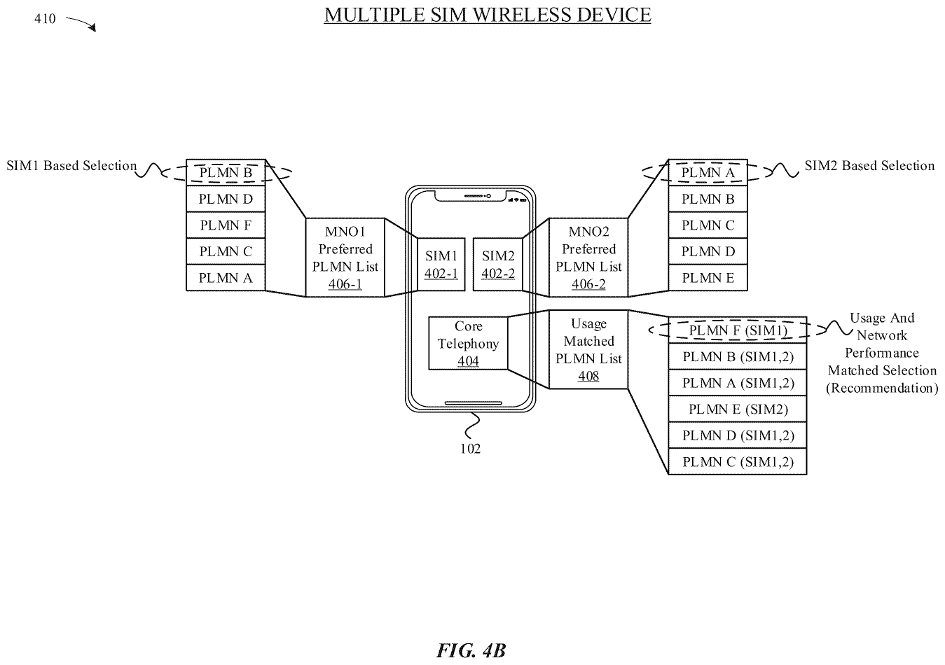

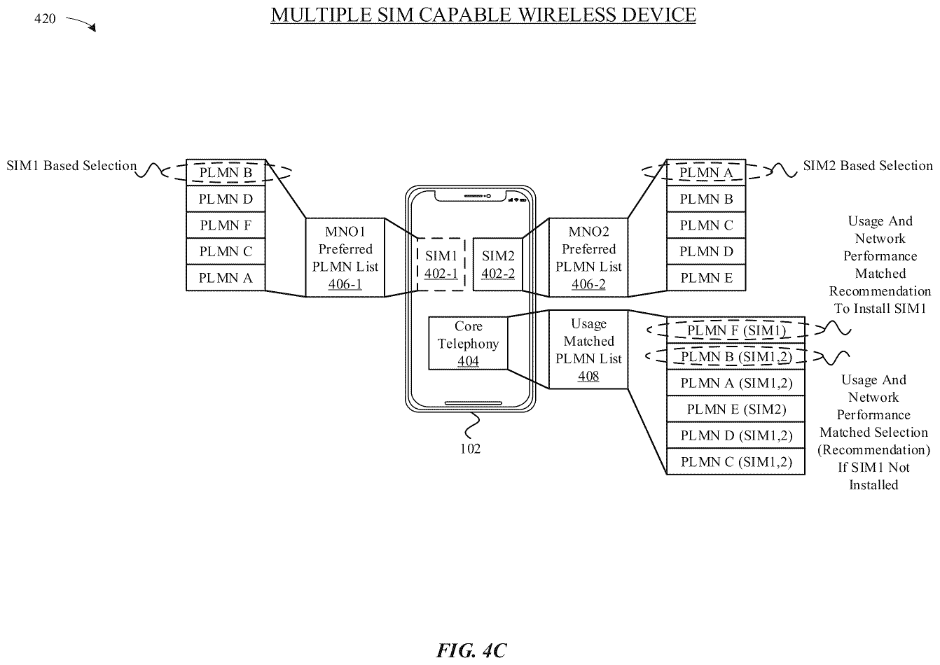

FIG. 4A illustrates a diagram 400 of an example of PLMN selection for a wireless device 102 that includes a single SIM 402. An MNO 114 associated with the SIM 402 can manage access to cellular wireless networks for the wireless device 102 based on data stored as part of the SIM 402, which can include an MNO preferred PLMN list 406 that indicates a prioritized set of PLMNs to which the wireless device 102 can associate and connect for access to cellular wireless services. The MNO preferred PLMN list 406 can also be referred to as an operator-preferred PLMN list (OPLMN list). While operating within a home region associated with the MNO 114, the wireless device 102 can establish connections to cellular wireless networks (PLMNs) of the MNO 114. When operating in a visited region where a PLMN of the MNO 114 is not available, the wireless device 102 can establish connections to a visited PLMN (VPLMN) of another MNO 114 with which the MNO 114 has a roaming agreement to allow for roaming cellular wireless access. The MNO 114 can have roaming agreements with multiple MNOs114 that operate different PLMNs across multiple different geographic regions, and the MNO preferred PLMN list 406 can be used to prioritize an order in which to connect to various PLMNs. The MNO preferred PLMN list 406 shown in FIG. 4A can also be specific for a geographic region in which the wireless device 102 is currently operating. For example, the PLMNs listed in the MNO preferred PLMN list 406 can share a common mobile country code (MCC) value and have distinct mobile network code (MNC) values. The MNO preferred PLMN list 406 can present an ordered set of indicators for PLMNs with which the wireless device 102 can associated and connect for access to cellular wireless service while roaming (unable to connect to the MNO 114 home PLMN) in a particular geographic region. The prioritized order of PLMNs in the MNO preferred PLMN list 406 can be determined by the MNO 114 and may be based on business and roaming agreements between the MNO 114 associated with the SIM 402 and other MNOs 114 that offer cellular wireless service via the PLMNs listed in the MNO preferred PLMN list 406. Based on the MNO preferred PLMN list 406 included with SIM 402, the wireless device 102 would prioritize connecting to PLMN A. As described herein, a core telephony module 404 of the wireless device 102 can determine a usage matched PLMN list 408 that is based on crowd-sourced network performance scores for different PLMNs matched to habitual usage behavior for the wireless device 102. The usage matched PLMN list 408 can account for observed cellular wireless network performance for different service quality and network quality characteristics, e.g., throughput, latency, call success, call drop, network accessibility, network retention, power saving configurations, of different PLMNs and also account for habitual usage behavior for the particular wireless device 102, e.g., data activity, latency critical activity, video calling, cellular voice usage, bursts internet data usage, lower power mode requirements. The usage matched PLMN list 408 can be sorted into a prioritized order of PLMNs that provides a best match between observed cellular wireless network performance and a particular device's usage. For example, as indicated in FIG. 4A, a device usage and network performance matched PLMN selection (or recommendation) can be for PLMN C using the usage matched PLMN list 408 rather than for PLMN A determined by the SIM based selection using the MNO preferred PLMN list. In some embodiments, a configuration of the wireless device 102 can allow for PLMN selection (e.g., while roaming) based on a usage matched PLMN list 408. In some embodiments, a configuration of the wireless device 102 can allow for automatic selection of best PLMNs using a usage matched PLMN list 408. In some embodiments, a configuration of the wireless device 102 can provide a recommendation for best PLMNs to use (e.g., while roaming) based on a usage matched PLMN list 408.

FIG. 4B illustrates a diagram 410 of an example of PLMN and SIM selection for a multiple SIM wireless device 102. The wireless device 102 includes a first SIM (SIM1) 402-1 associated with a first MNO (MNO1) and a second SIM (SIM2) 402-2 associated with a second MNO (MNO 2). The first SIM 402-1 can include a first preferred PLMN list 406-1 for MNO1, while the second SIM 402-2 can include a second preferred PLMN list 406-2 for MNO2. As described for the single SIM wireless device 102 of FIG. 4A, the MNO preferred PLMN lists 406-1, 406-2 indicate prioritized sets of PLMNs to which the wireless device 102 can associate and connect for access to cellular wireless services based on credentials of the respective SIMs 402-1, 402-2. The different SIMs 402-1, 402-2 can be associated with the same MNO 114 (e.g., MNO1 and MNO2 are the same) or with different MNOs 114. The MNO preferred PLMN lists 406-1, 406-2 can include identical, overlapping, or distinct lists of PLMNs. When operating in a visited geographic region, the wireless device could use none, one, or both of the SIMS 402-1, 402-2. More generally, a wireless device 102 with multiple SIMs 402 enabled can use between none and all of the enabled SIMs 402. As shown in FIG. 4B, each distinct SIM 402 can have its own MNO preferred PLMN list 406, and as a result a PLMN selection while roaming in a visited geographic region via the first SIM 402-1, e.g., PLMN B, can differ from a PLMN selection while roaming in the same visited geographic region for the second SIM 402-2, e.g., PLMN A. Each of the PLMNs selected by the respective SIMs 402-1, 402-2, however, are based on the MNO preferred PLMN lists 406-1, 406-2, and may not correspond to a best PLMN selection for the wireless device 102 based on habitual device usage matching to cellular wireless network performance scores for the different PLMNs available in the visited geographic region. The core telephony module 404 of the wireless device 102 can determine a usage matched PLMN list 408 that accounts for PLMNs available for multiple, e.g., for both SIMs 402-1, 402-2, and is based on matching habitual usage behavior of the wireless device 102 to cellular wireless network performance scores for the different PLMNs. As shown in FIG. 4B, for example, PLMN F associated with SIM1 (the first SIM 402-1) can be selected or recommended for use. In some embodiments, individual prioritized lists for each SIM of multiple SIMs, e.g., for the first SIM 402-1 and the second SIM 402-2, and selection or recommendation for a PLMN for the wireless device 102 to use can include PLMNs for each SIM. In some embodiments, the core telephony module 404 of the wireless device 102 determines a best SIM from multiple SIMs to use as a primary SIM while roaming based on a best matched PLMN from a usage matched PLMN list 408.

FIG. 4C illustrates a diagram 420 of an example of PLMN and SIM selection for a multiple SIM capable wireless device 102. The wireless device 102 can include a SIM (SIM2) 402-2 associated with MNO2 and that includes an MNO2 preferred PLMN list 406-2. The wireless device 102 can be capable of including additional SIMs, e.g., SIM1 402-1 associated with MNO1, but not have SIM1 402-1 installed. SIM1 402-1 can have an MNO1 preferred PLMN list 406-1 as determined by MNO1. When the wireless device 102 is roaming (or expected to roam) in a visited region, the core telephony module 404 can determine available PLMNs, match PLMNs based on cellular wireless network performance scores for the available PLMNs to habitual device usage to determine one or more best matched PLMNs for which an existing SIM in the wireless device 102 can be used or for which a new SIM can be installed in the wireless device 102. PLMN scores for various PLMNs across different communication service characteristics and cellular wireless network characteristics can be collected, normalized, and maintained by one or more network accessible servers, e.g., performance service server(s) 310. The wireless device 102 can obtain cellular network performance scores to use to compare against habitual device behavior usage to determine a best match between the device's usage and a network's expected performance matched to that usage. In some circumstances, the wireless device 102 includes multiple SIMs (e.g., as shown in FIG. 4B) and a PLMN and SIM combination can selected or recommended for use based on the matching of PLMN performance to device usage. In some circumstances, the wireless device 102 supports use of multiple SIMs and a best PLMN and SIM combination can be recommended for installation of a SIM to the wireless device 102 for use while roaming. As shown in FIG. 4C, a usage and network performance matched recommendation to install SIM1 (e.g., to use with PLMN F) can be provided. If SIM1 is installed, then SIM1 can be selected for use while roaming. In some cases, multiple SIMs that correspond to use of PLMN F can be available for installation, and a user of the wireless device 102 can be presented options or directed to web pages or application store fronts from which to purchase and install a well-matched SIM. When no new SIM is installed, a SIM and PLMN combination can be selected from those SIMs already available in the wireless device 102. For example, PLMN B and SIM2 402-2 can be used while roaming if SIM1 is not installed to allow use of PLMN F.

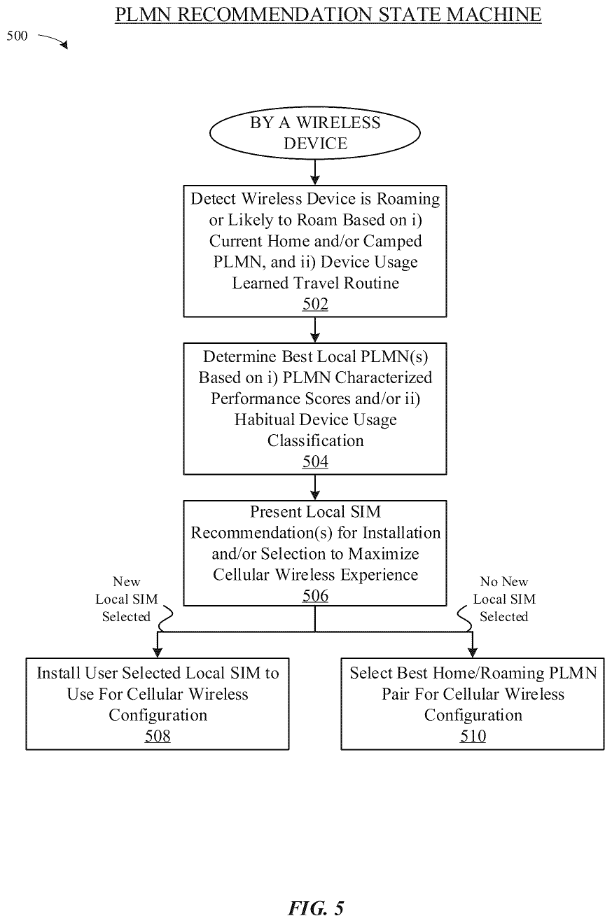

FIG. 5 illustrates a flowchart 500 of an exemplary PLMN recommendation state machine that can be implemented by a core telephony module 404 of a wireless device 102. At step 502, the core telephony module 404 of the wireless device 102 can determine that the wireless device 102 is roaming in or likely to roam to a visited geographic region based on i) a current home PLMN (e.g., associated with a SIM of the wireless device 102) and/or based on a camped PLMN (e.g., which may be a home PLMN or may be a visited PLMN) and ii) habitual device usage information, such as a learned travel routine. At step 504, the core telephony module 404 of the wireless device 102 can determine a best local PLMN matched to the wireless device 102 based on i) PLMN characterized performance scores and/or ii) habitual device usage classification (which can indicate how a device is most frequently used for cellular wireless communication purposes). The habitual device usage classification and PLMN matching can be performed internal to the wireless device 102 to maintain user privacy. At step 506, the core telephony module 404 of the wireless device 102 can provide recommendation for installation and/or selection of one or more SIMs to use based on matching the habitual device usage to the PLMN performance scores. In some cases, the core telephony module 404 recommends one or more local SIMs that can be installed to maximize cellular wireless experience for the particular wireless device 102. At step 508, when a new local SIM is selected for installation, e.g., based on user input, the core telephony module 404 of the wireless device 102 can trigger installation of a user selected local SIM and configure the wireless device 102 to use the local SIM for cellular wireless communication. At step 510, when no new local SIM is selected for installation, a best matched roaming PLMN and associated SIM available in the wireless device 102 can be selected to use for cellular wireless communication.

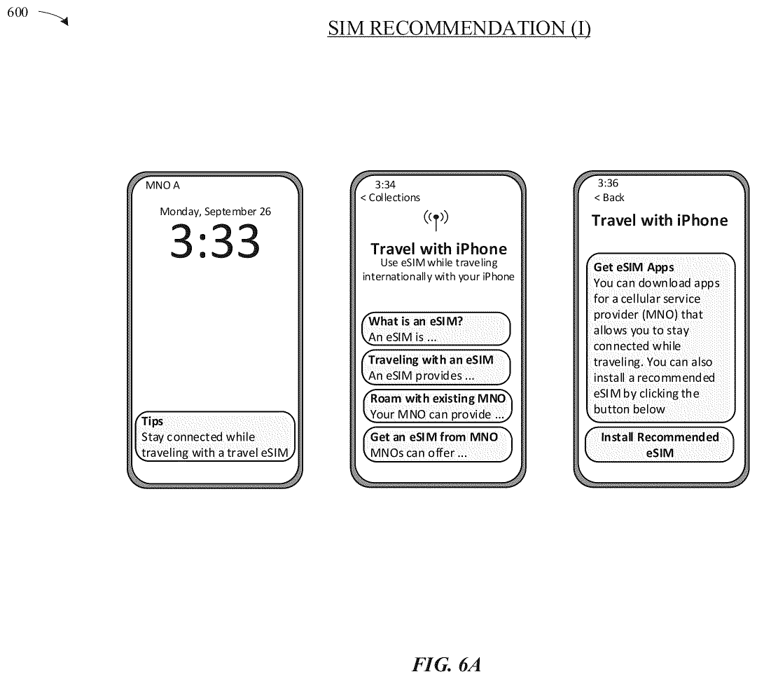

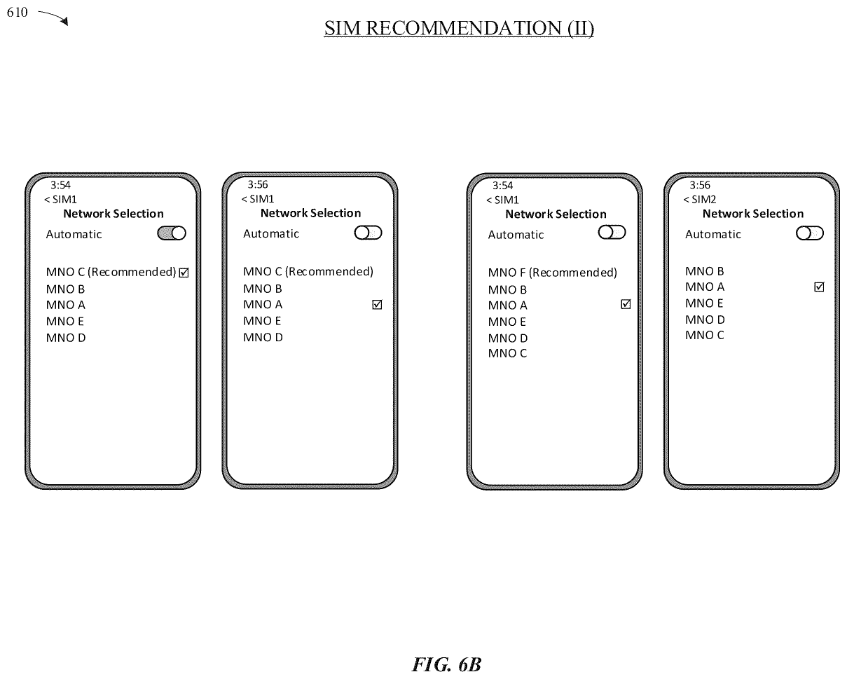

FIGS. 6A and 6B illustrate diagrams 600 and 610 respectively of exemplary user interface (UI) displays for recommending SIMs for a wireless device 102. A user tip can be displayed to prompt the user to learn more about wireless communication connectivity while traveling, e.g., such as to obtain a travel SIM (e.g., an eSIM or iSIM). The UI displays for the wireless device can provide options for learning about how SIMs function, how SIMs can be used when traveling (roaming), how to roam using an already installed MNO SIM, and how to obtain new SIMs from one or more MNOs, which can correspond to available PLMNs. In some cases, a UI can display one or more SIMs recommended for installation to the wireless device 102. In some cases, cellular wireless network selection can be configured to be automatically selected by the wireless device, and a recommended MNO (PLMN) selection for a SIM can be displayed and selected. In some cases, cellular wireless network selection can be configured to be manually selected, and a recommended MNO (PLMN) corresponding to a SIM available in the wireless device 102 can be indicated (which may differ from a selected MNO used by the SIM). When a wireless device 102 includes multiple SIMs recommendations for which MNO (PLMN) to use for each SIM or a single recommendation for an MNO (PLMN) from all SIMs can be provided.

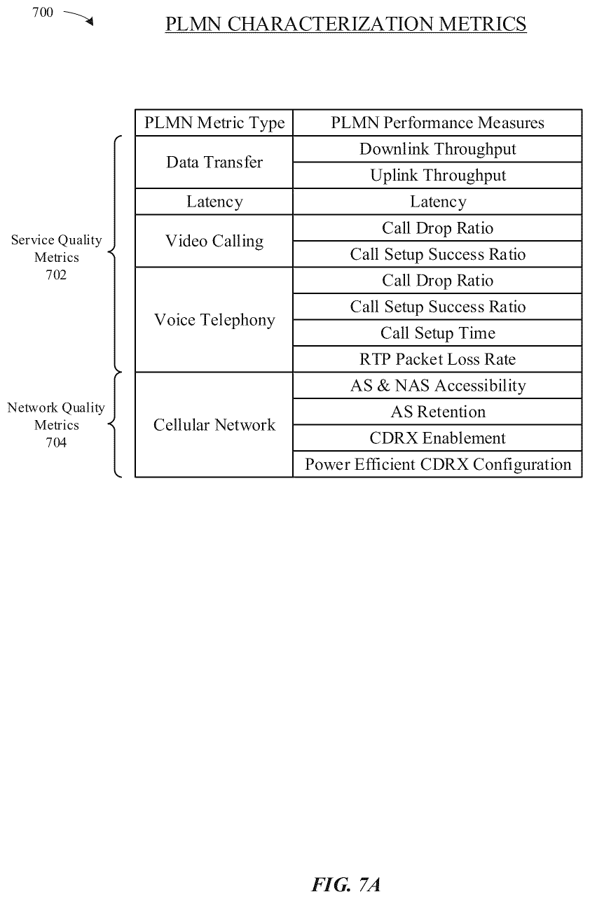

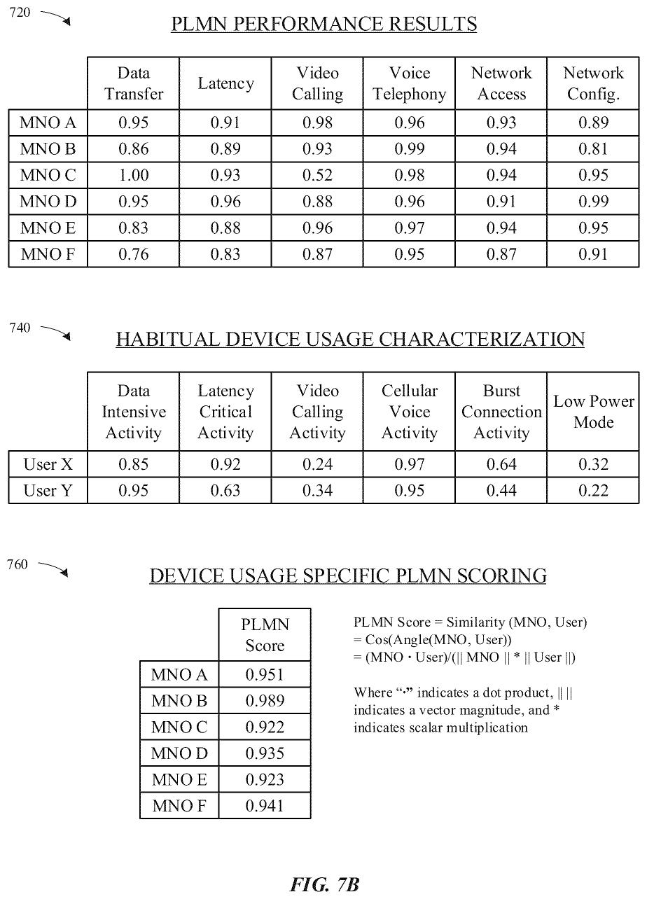

FIG. 7A illustrates a table 700 of exemplary metrics that can be used to characterize a cellular wireless network, i.e., a PLMN, based on crowd-sourced information provided by multiple wireless devices 102, e.g., collected, analyzed, and maintained by one or more performance service servers 310. The PLMN characterization metrics can be grouped into a set of service quality metrics 702 that can directly indicate performance measures for cellular wireless service usage and a set of network quality metrics 704 that can indicate performance for connecting to and with a cellular wireless network. Service quality metrics 702 can include metrics based on data transfer rates, e.g., downlink throughput and uplink throughput. Different wireless device 102 can experience different metrics at different times and different locations for a given PLMN, and the metrics can include statistical information regarding measurements of data transfer rates, e.g., median, average, lowest tenth percentile, highest tenth percentile, etc. Data transfer metrics can be useful for determining a PLMN match to a wireless device 102 with relatively higher usage of data transfer intensive activities. Service quality metrics 702 can also include metrics for data transfer latency experienced by different wireless devices 102 while connected to a PLMN. Latency metrics can be applicable for matching a PLMN to a wireless device 102 used with latency critical applications, such as gaming. Service quality metrics 702 can further include video calling metrics for real-time video calls, such as call setup success measures and call drop measures. Video calling metrics can be applicable for matching a PLMN to a wireless device 102 used frequently with video calling applications, such as FaceTime®. Service quality metrics 702 can also include voice telephony metrics for cellular voice calling, such as call setup success and call drop measures, time to setup a call, and real-time transport protocol (RTP) packet loss rate. Voice telephony metrics can assist with matching a PLMN to a wireless device 102 that has relatively high usage for cellular wireless telephony calling. Network quality metrics 704 can include cellular wireless network performance metrics, such as accessibility to the access stratum (AS) and non-access stratum (NAS) layers and AS layer retention rate, as well as network configuration settings regarding connected mode discontinuous reception (CDRX) enablement and power efficient CDRX configuration settings, which can be applicable to a wireless device 102 prioritized for use in a lower power mode.

FIG. 7B illustrates tables, 720, 740, 760 of an example of determining performance scores for PLMNs based on matching PLMN characterization metrics to habitual device usage characteristics of a wireless device 102. Table 720 summarizes PLMN performance scores for several different MNOs 114 across multiple performance characteristic metrics normalized to a range from 0 to 1. One or more performance service servers 310 can collect PLMN performance measures from multiple wireless devices 102 over time, process the measured PLMN performance information into normalized performance scores, and provide the PLMN performance scores to a wireless device 102 periodically, on demand, or responsive to a request for PLMN performance scores from the wireless device 102 prompted by a push notification indicating availability of up-to-date PLMN performance scores. In some embodiments, the wireless device 102 obtains PLMN performance scores for multiple geographic regions worldwide. In some embodiments, the wireless device 102 obtains PLMN performance scores for a home geographic region for the wireless device 102 (e.g., based on a SIM installed in the wireless device 102). In some embodiments, the wireless device 102 obtains PLMN performance scores for a visited (or to be visited) geographic region different from a home geographic region for the wireless device 102. A wireless device 102 can use the PLMN performance scores to match PLMNs for different MNOs 114 to habitual device usage of the wireless device 102. PLMNs that are applicable to a geographic region in which the wireless device 102 is operating or expected to operate can be compared based on performance scoring. PLMNs for particular MNOs applicable to a geographic region can be determined based on a mobile country code (MCC) for the PLMN.

Table 740 summarizes habitual device usage of a wireless device 102 across different usage categories normalized to a range from 0 to 1. Habitual device usage can be determined by the wireless device based on past history usage of cellular wireless communication and various applications that can use cellular wireless communication capabilities. Habitual device usage can be stored in the wireless device 102 and encrypted or otherwise obscured when transferring the habitual device usage to another wireless device 102 in order to preserve user privacy of the habitual device usage information. In some embodiments, different users may share a wireless device 102, and habitual device usage can be maintained for each individual user of the wireless device 102. The habitual device usage provides normalized scores for various activities of the wireless device 102 that relate to cellular wireless communication. Examples of data that can be used to characterize habitual device usage include: an amount of real time calling (measured in time units), an amount or size of internet pages rendered (measured in data size units), an amount of cellular data downloads (measured in data size units), an amount if video streaming (measured in time units), a count of connections with data burst activity over a time interval, an amount of low power usage (measured in time units). The data can be normalized and/or combined together with various weighting factors to arrive at a normalized characterization of habitual device usage across multiple categories as summarized in table 740. Data captured as time units can be normalized as a percentage of total time that the wireless device 102 is active, e.g., using a total time that a display is on (rather than off) as a base measure for total time units. For example, an amount of time that the wireless device 102 is used for cellular voice calling can be normalized by dividing a total amount of time that the wireless device 102 is actively used for a given time period. Data captured in data size units can be normalized as a percentage of total data usage. For example, an amount of data downloaded for internet page rendering and cellular data downloads over a time period can be normalized by a total amount of wireless data usage (which can include non-cellular data downloading) by the wireless device 102 during the same time period. A count of burst connections can also be normalized as a percentage of a total number of cellular wireless connections by the wireless device 102 during a time period. The habitual device usage normalized characterization metrics can be represented as a vector, and additional metrics can be added to customize or update a habitual device usage model for the wireless device 102. The habitual device usage characterization vector for the wireless device 102 can be periodically updated by the wireless device 102 based on most recent user behavior. The habitual usage characterization vector for the wireless device 102 can be stored in the wireless device and an encrypted copy can be stored external to the wireless device, e.g., in a network accessible cloud service account, which can permit transfer of the habitual usage characterization vector to another wireless device 102, such as a wireless device 102 that replaces a currently used wireless device 102 or another wireless device 102 in a set of wireless devices 102 that can share a common user account, such as a cloud service account (e.g., a set of wireless devices 102 as depicted in FIG. 3).

Table 760 summarizes PLMN performance scores for each of multiple PLMNs from table 720 when compared against the habitual device usage of a wireless device 102 (or of a particular user of the wireless device 102) from table 760. An overall wireless device usage specific performance score for a PLMN can be determined by computing a similarity value between a vector of normalized PLMN performance scores for the PLMN, e.g., a row of table 720 for a particular MNO, and a vector of normalized habitual device usage characterization values for a wireless device 102, e.g., a row of table 740. A representative similarity metric is a cosine similarity value used to measure a similarity of two vectors of the same length as in Equation (1), where θ indicates the angle between vectors X and Y, the operator “.” indicates a dot product between the two vectors X and Y, ∥X∥ indicates a magnitude of the vector X, where the magnitude of a vector X can be computed as a square root of the sum of squared values of each scalar element xᵢ of the vector X as in Equation (2), and the operator “*” indicates scalar multiplication.

$$Similarity ( X , Y ) = Cos ( θ ) = \frac{X \cdot Y}{‖ X ‖ * ‖ Y ‖} \qquad ( 1 )$$

$$‖ X ‖ = \sqrt{{\sum }_{i} {x}_{i}^{2}} \qquad ( 2 )$$

Different PLMNs (indicated by their associated MNO identifiers) can be compared to one another and ranked based on the device usage specific PLMN performance scores, e.g., as summarized in table 760, to recommend one or more PLMNs to which to connect for a given SIM and/or for determining SIM/PLMN pairs to recommend, e.g., for download and installation to the wireless device 102, or to select from among multiple SIMs installed on the wireless device 102 and multiple PLMNs available in a geographic region in which the wireless device is operating or expected to operate. The results shown in table 760 indicate MNO B as a best matched PLMN for habitual device usage of the wireless device 102.

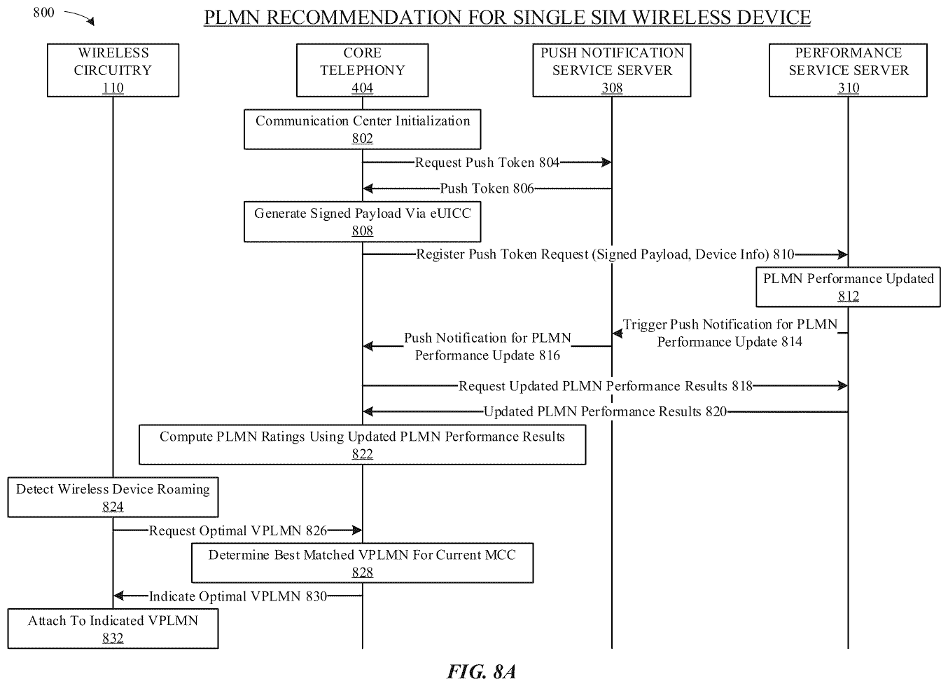

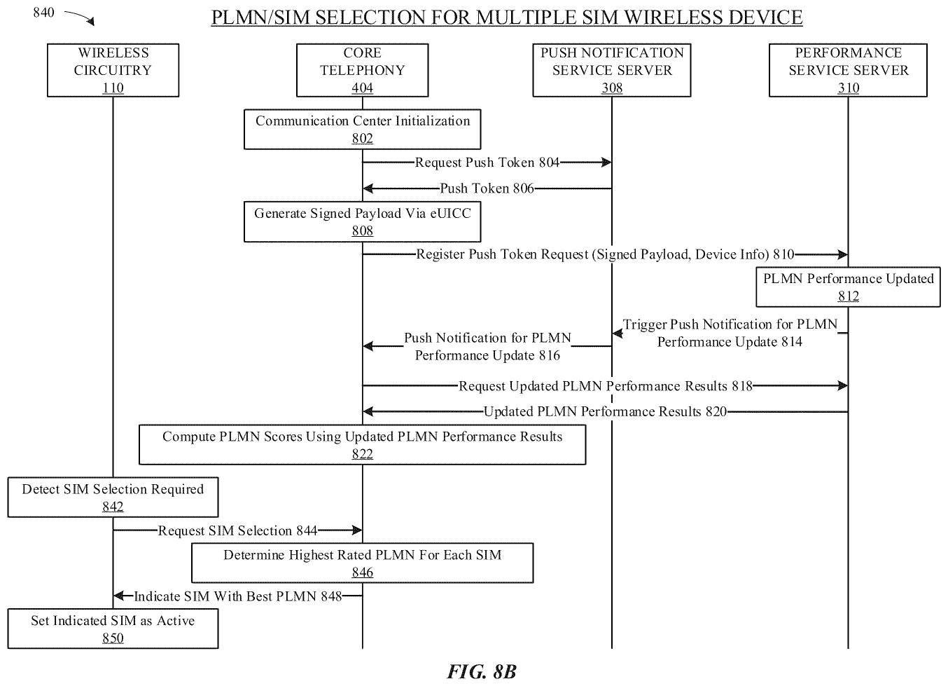

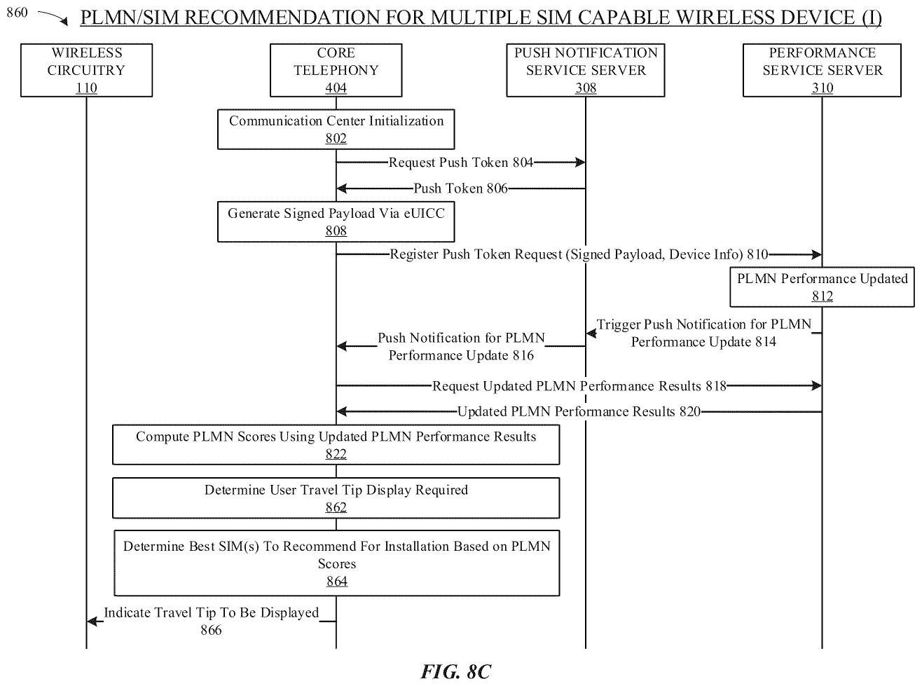

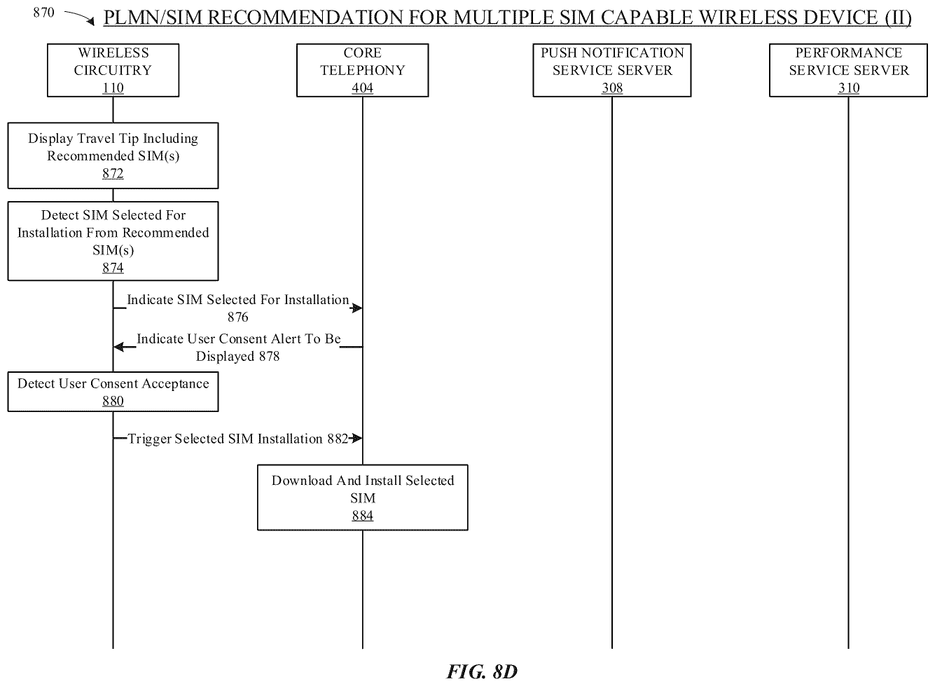

FIG. 8A illustrates a flowchart 800 of an example of determining a PLMN recommendation for a single SIM wireless device 102. At step 802, a core telephony module 404 of the single SIM wireless device 102 performs a communication center initialization procedure. At step 804, the core telephony module 404 sends a message to a push notification service server 308 requesting a push token. At step 806, the push notification service server 308 responds to the request from the core telephony module 404 of the single SIM wireless device 102 with a push token. At step 808, the core telephony module 404 generates a payload, signed by an eUICC 108 of the single SIM wireless device 102, where the signed payload includes the push token received from the push notification service server 308. At step 810, the core telephony module 404 sends a message to a performance service server 310 to request registration of the single SIM wireless device 102 to obtain push notifications that may indicate availability of updates to PLMN performance data maintained by the performance service server 310. At step 812, PLMN performance information for one or more PLMNs are updated by the performance service server 310 based on information collected from multiple wireless devices 102. At step 814, the performance service server 310 sends a message to the push notification service server 308 to trigger a push notification to one or more wireless devices 102 indicating availability of PLMN performance updates from the performance service server 310. At step 816, the push notification service server 308 sends a push notification message to the core telephony module 404 of the single SIM wireless device 102 indicating availability of updates to PLMN performance data from the performance service server 310. At step 818, the core telephony module 404 of the single SIM wireless device 102 sends a message to the performance service server 310 requesting updated PLMN performance data. At step 820, the performance service server 310 responds to the core telephony module 404 of the single SIM wireless device 102 with updated PLMN performance data. At step 822, the core telephony module 404 of the single SIM wireless device 102 computes ratings for various PLMNs based on the updated PLMN performance data received from the performance service server 310. PLMN performance scores can be compared to habitual device usage of the single SIM wireless device 102 to determine similarity measures, e.g., as described herein regarding FIGS. 7A and 7B. At step 824, wireless circuitry 110 of the single SIM wireless device 102 detects that the single SIM wireless device 102 is roaming (or likely to roam) in a visited geographic region. At step 826, the wireless circuitry 110 queries the core telephony module 404 for an optimal visited PLMN (VPLMN) to use in the visited geographic region. At step 828, the core telephony module 404 obtains a mobile country code (MCC) value for the visited geographic region and determines a best matching VPLMN using the ratings computed in step 822 for the wireless device 102 to use for cellular wireless communication while roaming in the visited geographic region. At step 830, the core telephony module 404 provides to the wireless circuitry 110 an indication of an optimal (best matched) VPLMN to be used while roaming in the visited geographic region. At step 832, the wireless circuitry 110 of the single SIM wireless device attaches to the indicated VPLMN while roaming in the visited geographic region.

FIG. 8B illustrates a flowchart 840 of an example of selecting a PLMN and SIM pair for a multiple SIM wireless device 102. At step 802, a core telephony module 404 of the multiple SIM wireless device 102 performs a communication center initialization procedure. At step 804, the core telephony module 404 sends a message to a push notification service server 308 requesting a push token. At step 806, the push notification service server 308 responds to the request from the core telephony module 404 of the multiple SIM wireless device 102 with a push token. At step 808, the core telephony module 404 generates a payload, signed by an eUICC 108 of the multiple SIM wireless device 102, where the signed payload includes the push token received from the push notification service server 308. At step 810, the core telephony module 404 sends a message to a performance service server 310 to request registration of the multiple SIM wireless device 102 to obtain push notifications that may indicate availability of updates to PLMN performance data maintained by the performance service server 310. At step 812, PLMN performance information for one or more PLMNs are updated by the performance service server 310 based on information collected from multiple wireless devices 102. At step 814, the performance service server 310 sends a message to the push notification service server 308 to trigger a push notification to one or more wireless devices 102 indicating availability of PLMN performance updates from the performance service server 310. At step 816, the push notification service server 308 sends a push notification message to the core telephony module 404 of the multiple SIM wireless device 102 indicating availability of updates to PLMN performance data from the performance service server 310. At step 818, the core telephony module 404 of the multiple SIM wireless device 102 sends a message to the performance service server 310 requesting updated PLMN performance data. At step 820, the performance service server 310 responds to the core telephony module 404 of the multiple SIM wireless device 102 with updated PLMN performance data. At step 822, the core telephony module 404 of the multiple SIM wireless device 102 computes ratings for various PLMNs based on the updated PLMN performance data received from the performance service server 310. PLMN performance scores can be compared to habitual device usage of the single SIM wireless device 102 to determine similarity measures, e.g., as described herein regarding FIGS. 7A and 7B. At step 842, wireless circuitry 110 of the multiple SIM wireless device 102 detects that selection of a SIM for the multiple SIM wireless device 102 is required. At step 844, the wireless circuitry 110 queries the core telephony module 404 for a SIM selection. At step 846, the core telephony module 404 determines a highest rated (best matched to habitual device usage of the multiple SIM wireless device 102) PLMN for one or more SIMs of the multiple SIM wireless device 102. In some embodiments, only those SIMs applicable to geographic region in which the multiple SIM wireless device 102 is operating are considered for use. In some embodiments, one or more SIMs applicable to a geographic region to which the multiple SIM wireless device 102 is expected to be used, e.g., based on a travel routine to a different geographic region than currently used, are considered to determine a best matching PLMN. In some embodiments, the core telephony module 404 determines a best matching PLMN for each SIM available in the multiple SIM wireless device 102. In some embodiments, the core telephony module 404 selects a SIM having a highest rated (best matched based on habitual device usage) for use by the multiple SIM wireless device 102. At step 848, the core telephony module 404 provides to the wireless circuitry 110 an indication of the SIM and the best matched PLMN for the indicated SIM. At step 850, the wireless circuitry 110 of the multiple SIM wireless device sets the indicated SIM as an active SIM for the multiple SIM wireless device 102, which in some cases can cause a change in which SIM is active on the multiple SIM wireless device 102.

FIGS. 8C and 8D illustrate flowcharts 860, 870 of an example of determining a recommended PLMN and SIM pair for a multiple SIM capable wireless device 102. A multiple SIM capable wireless device 102 can include a wireless device 102 in which one SIM (or no SIMs) are installed and which can support the installation and use of multiple SIMs. A multiple SIM capable wireless device 102 can also be a wireless device 102 having multiple SIMs installed thereon that also supports installation and use of additional SIMs. At step 802, a core telephony module 404 of the multiple SIM capable wireless device 102 performs a communication center initialization procedure. At step 804, the core telephony module 404 sends a message to a push notification service server 308 requesting a push token. At step 806, the push notification service server 308 responds to the request from the core telephony module 404 of the multiple SIM capable wireless device 102 with a push token. At step 808, the core telephony module 404 generates a payload, signed by an eUICC 108 of the multiple SIM capable wireless device 102, where the signed payload includes the push token received from the push notification service server 308. At step 810, the core telephony module 404 sends a message to a performance service server 310 to request registration of the multiple SIM capable wireless device 102 to obtain push notifications that may indicate availability of updates to PLMN performance data maintained by the performance service server 310. At step 812, PLMN performance information for one or more PLMNs are updated by the performance service server 310 based on information collected from multiple wireless devices 102. At step 814, the performance service server 310 sends a message to the push notification service server 308 to trigger a push notification to one or more wireless devices 102 indicating availability of PLMN performance updates from the performance service server 310. At step 816, the push notification service server 308 sends a push notification message to the core telephony module 404 of the multiple SIM capable wireless device 102 indicating availability of updates to PLMN performance data from the performance service server 310. At step 818, the core telephony module 404 of the multiple SIM capable wireless device 102 sends a message to the performance service server 310 requesting updated PLMN performance data. At step 820, the performance service server 310 responds to the core telephony module 404 of the multiple SIM capable wireless device 102 with updated PLMN performance data. At step 822, the core telephony module 404 of the multiple SIM capable wireless device 102 computes ratings for various PLMNs based on the updated PLMN performance data received from the performance service server 310. PLMN performance scores can be compared to habitual device usage of the single SIM capable wireless device 102 to determine similarity measures, e.g., as described herein regarding FIGS. 7A and 7B. At step 862, the core telephony module 404 of the multiple SIM capable wireless device 102 determines that display of a user travel tip is required (or recommended), e.g., based on determination that the multiple SIM capable wireless device 102 is roaming in (or likely to roam to) a visited geographic region. At step 864, the core telephony module 404 determines one or more SIMs that are best matched based on PLMN performance scores for the one or more SIMs to habitual device usage of the multiple SIM capable wireless device 102 to recommend for installation to the multiple SIM capable wireless device 102. At step 866, the core telephony module 404 sends a message to the wireless circuitry 110 to indicate that a travel tip should be displayed. At step 872, the wireless circuitry 110 causes a travel tip that includes one or more recommended SIMs for installation to the wireless device 102 to be displayed. At step 874, the wireless circuitry 110 detects selection of a SIM (or of multiple SIMs), from the one or more recommended SIMs, to be installed to the multiple SIM capable wireless device 102. At step 876, the wireless circuitry 110 provides an indication to the core telephony module 404 of the SIM (or SIMs) selected for installation. At step 878, the core telephony module 404 sends to the wireless circuitry 110 a message indicating that a user consent alert message should be displayed. At step 880, the wireless circuitry 110 detects an indication of acceptance of user consent to install the SIM (or SIMs) selected for installation. At step 882, the wireless circuitry 110 sends a message to the core telephony module 404 to trigger installation of the selection SIM (or SIMs). At step 884, the core telephony module 404 causes the multiple SIM capable wireless device 102 to download and install the selected SIM (or SIMs).

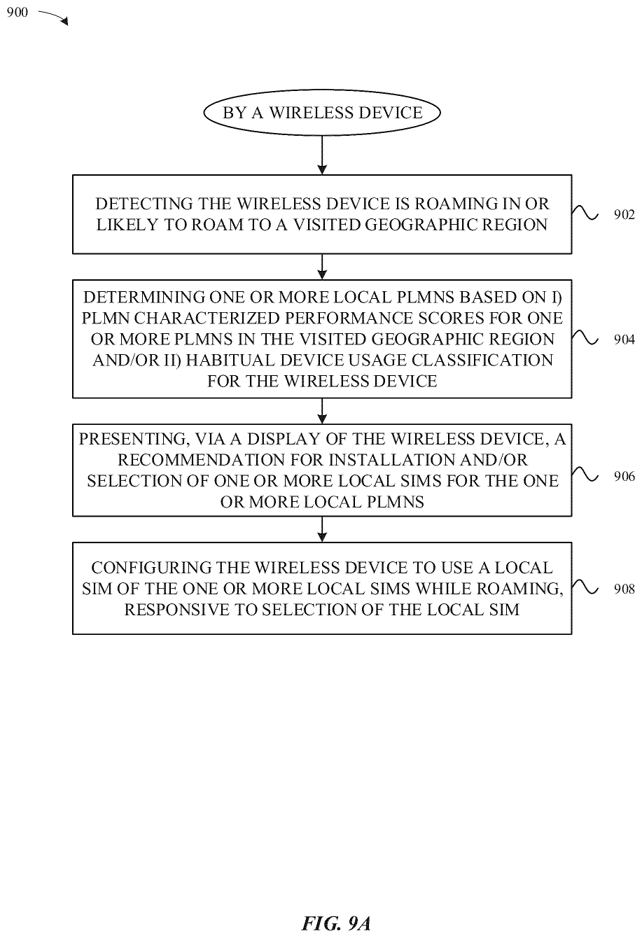

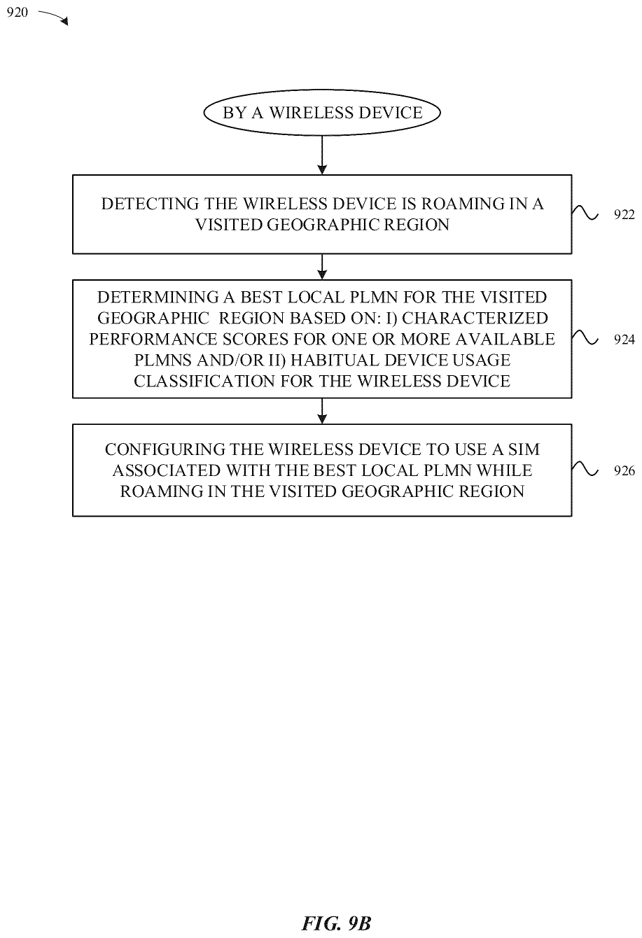

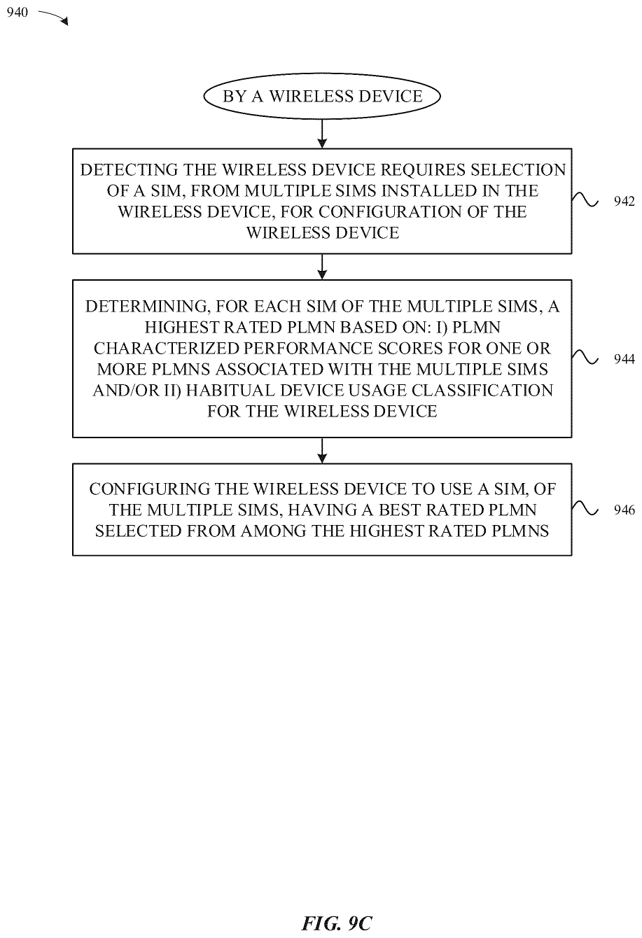

FIG. 9A illustrates a flowchart 900 of an exemplary method performed by a wireless device 102 to determine a SIM and/or a PLMN matched to device usage of the wireless device 102. At step 902, the wireless device 102 detects that the wireless device 102 is roaming in or likely to roam to a visited geographic region. At step 904, the wireless device 102 determines one or more local PLMNs based on i) PLMN characterized performance scores for one or more PLMNs in the visited geographic region and/or ii) habitual device usage classification for the wireless device 102. At step 906, the wireless device 102 presents, via a display of the wireless device 102, a recommendation for installation and/or selection of one or more local SIMs for the one or more local PLMNs. At step 908, the wireless device 102 configures the wireless device 102 to use a local SIM of the one or more local SIMs while roaming, responsive to selection of the local SIM. The local SIM can be in the form of an eSIM 208 of an iSIM based on capabilities of the wireless device 102.

In some embodiments, the method further includes the wireless device 102 installing the local SIM in the wireless device 102, responsive to selection of the local SIM. In some embodiments, the method further includes the wireless device 102, when no selection of a local SIM of the one or more local SIMs is obtained, i) determining a best home PLMN and local roaming PLMN pair for roaming by the wireless device, and ii) configuring the wireless device 102 to use a SIM associated with the local roaming PLMN while roaming. In some embodiments, the PLMN characterized performance scores include one or more of: i) a data transfer score, ii) a latency score, iii) a video calling score, iv) a voice telephony score, v) a network access score, or vi) a network configuration score. In some embodiments, the determination of the one or more local PLMNs is based on habitual device usage classification for the wireless device. In some embodiments, the habitual device usage classification for the wireless device includes one or more of: i) a data intensive activity metric; ii) a latency critical activity metric, iii) a video calling activity metric, iv) a cellular voice activity metric, v) a burst connection activity metric, or vi) a low power mode metric. In some embodiments, determination of the one or more PLMNs includes computing, for each PLMN of the one or more PLMNs, a similarity metric that compares a PLMN vector of the PLMN characterized performance scores for the corresponding PLMN to a device vector of the habitual device usage classification for the wireless device. In some embodiments, the method performed by the wireless device 102 further includes: i) registering with a performance service server 310 for notification of updates to the PLMN characterized performance scores, and ii) obtaining from the performance service server 310 updates to the PLMN characterized performance scores, where determination of the one or more local PLMNs is further based on the updates to the PLMN characterized performance scores. In some embodiments, the PLMN characterized performance scores are obtained by the wireless device 102 from a performance service server 310 that agglomerates crowd-sourced performance metrics for PLMNs from multiple wireless devices 102. In some embodiments, the method performed by the wireless device 102 further includes: i) determining a requirement for displaying a travel tip regarding use of SIMs while roaming, and ii) presenting, via the display of the wireless device 102, the travel tip in conjunction with display of the recommendation for installation and/or selection of one or more local SIMs for the one or more local PLMNs.

FIG. 9B illustrates a flowchart 920 of another exemplary method performed by a wireless device 102 to determine a SIM and/or a PLMN matched to device usage of the wireless device 102. At step 922, the wireless device 102 detects that the wireless device 102 is roaming in a visited geographic region. At step 924, the wireless device 102 determines a best local PLMN for the visited geographic region based on: i) characterized performance scores for one or more available PLMNs, and/or ii) habitual device usage classification for the wireless device 102. At step 926, the wireless device 102 configures the wireless device 102 to use a SIM associated with the best local PLMN while roaming in the visited geographic region.

In some embodiments, the method further includes the wireless device 102 attaching the wireless device 102 to the best local PLMN while in the visited geographic region. In some embodiments, the PLMN characterized performance scores include one or more of: i) a data transfer score, ii) a latency score, iii) a video calling score, iv) a voice telephony score, v) a network access score, or vi) a network configuration score. In some embodiments, determination of the best local PLMN is based on habitual device usage classification for the wireless device. In some embodiments, the habitual device usage classification for the wireless device 102 includes one or more of: i) a data intensive activity metric; ii) a latency critical activity metric, iii) a video calling activity metric, iv) a cellular voice activity metric, v) a burst connection activity metric, or vi) a low power mode metric. In some embodiments, determination of the best local PLMN includes computing, for each PLMN of the one or more PLMNs, a similarity metric that compares a PLMN vector of the PLMN characterized performance scores for the corresponding PLMN to a device vector of the habitual device usage classification for the wireless device 102. In some embodiments, the method further includes the wireless device 102: i) registering with a performance service server for notification of updates to the PLMN characterized performance scores, and ii) obtaining from the performance service server updates to the PLMN characterized performance scores, where determination of the best local PLMN is further based on the updates to the PLMN characterized performance scores. In some embodiments, the PLMN characterized performance scores are obtained by the wireless device 102 from a performance service server that agglomerates crowd-sourced performance metrics for PLMNs from multiple wireless devices 102.

FIG. 9C illustrates a flowchart 940 of an additional exemplary method performed by a wireless device 102 to determine a SIM and/or a PLMN matched to device usage of the wireless device 102. At step 942, the wireless device 102 detects the wireless device 102 requires selection of a SIM, from multiple SIMs installed in the wireless device 102, for configuration of the wireless device 102. At step 944, the wireless device 102 determines, for each SIM of the multiple SIMs, a highest rated PLMN based on: i) PLMN characterized performance scores for one or more PLMNs associated with the multiple SIMs, and/or ii) habitual device usage classification for the wireless device 102. At step 946, the wireless device 102 configures the wireless device 102 to use a SIM, of the multiple SIMs, having a best rated PLMN selected from among the highest rated PLMNs.

In some embodiments, the method performed by the wireless device 102 further includes presenting, via a display of the wireless device 102, an indication of the best PLMN and associated SIM selected for configuration of the wireless device 102. In some embodiments, the PLMN characterized performance scores include one or more of: i) a data transfer score, ii) a latency score, iii) a video calling score, iv) a voice telephony score, v) a network access score, or vi) a network configuration score. In some embodiments, determination of the highest rated PLMN is based on habitual device usage classification. In some embodiments, the habitual device usage classification for the wireless device includes one or more of: i) a data intensive activity metric; ii) a latency critical activity metric, iii) a video calling activity metric, iv) a cellular voice activity metric, v) a burst connection activity metric, or vi) a low power mode metric. In some embodiments, determination of the highest rate PLMN includes computing, for each PLMN of the one or more PLMNs associated with the multiple SIMs, a similarity metric that compares a PLMN vector of the PLMN characterized performance scores for the corresponding PLMN to a device vector of the habitual device usage classification for the wireless device 102. In some embodiments, the method performed by the wireless device 102 further includes: i) registering with a performance service server for notification of updates to the PLMN characterized performance scores, and ii) obtaining, from the performance service server, updates to the PLMN characterized performance scores, where determination of the highest rated PLMN is further based on the updates to the PLMN characterized performance scores. In some embodiments, the PLMN characterized performance scores are obtained by the wireless device 102 from a performance service server that agglomerates crowd-sourced performance metrics for PLMNs from multiple wireless devices 102.

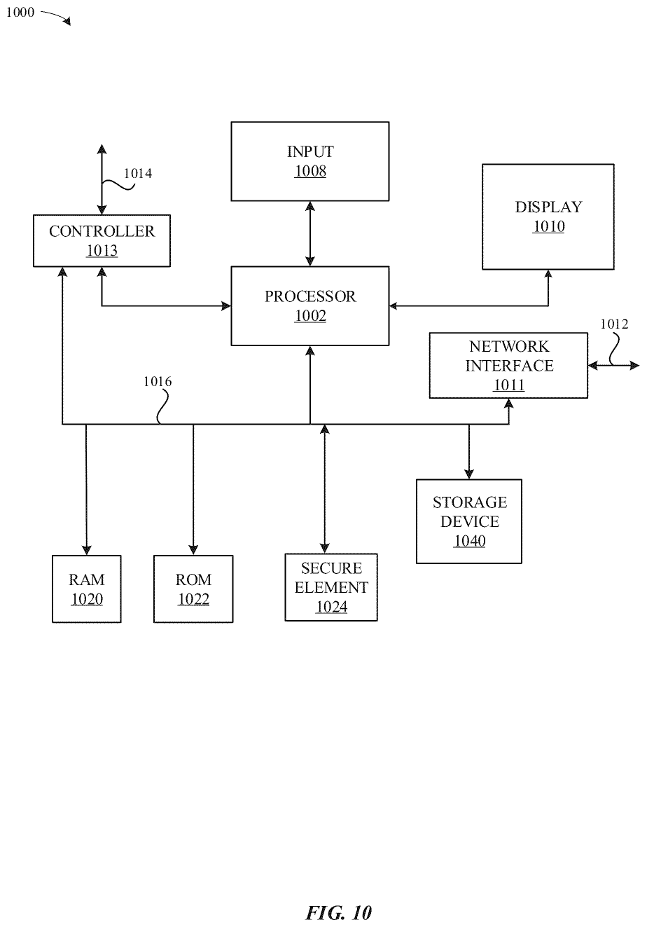

FIG. 10 illustrates a detailed view of a representative computing device 1000 that can be used to implement various methods described herein, according to some embodiments. In particular, the detailed view illustrates various components that can be included in the wireless device 102, any of the wireless devices 102A, 102B, 102C, or any other wireless device as discussed herein. As shown in FIG. 10, the computing device 1000 can include a processor 1002 that represents a microprocessor or controller for controlling the overall operation of computing device 1000. The computing device 1000 can also include a user input device 1008 that allows a user of the computing device 1000 to interact with the computing device 1000. For example, the user input device 1008 can take a variety of forms, such as a button, keypad, dial, touch screen, audio input interface, visual/image capture input interface, input in the form of sensor data, etc. Still further, the computing device 1000 can include a display 1010 that can be controlled by the processor 1002 to display information to the user. A data bus 1016 can facilitate data transfer between at least a storage device 1040, the processor 1002, and a controller 1013. The controller 1013 can be used to interface with and control different equipment through an equipment control bus 1014. The computing device 1000 can also include a network/bus interface 1011 that communicatively couples to a data link 1012. In the case of a wireless connection, the network/bus interface 1011 can include a wireless transceiver.

The computing device 1000 also includes a storage device 1040, which can comprise a single disk or a plurality of disks (e.g., hard drives), and includes a storage management module that manages one or more partitions within the storage device 1040. In some embodiments, storage device 1040 can include flash memory, semiconductor (solid state) memory or the like. The computing device 1000 can also include a Random Access Memory (RAM) 1020 and a Read-Only Memory (ROM) 1022. The ROM 1022 can store programs, utilities or processes to be executed in a non-volatile manner. The RAM 1020 can provide volatile data storage, and stores instructions related to the operation of the computing device 1000. The computing device 1000 can further include a secure element (SE) 1024, which can represent secure storage for credentials for cellular wireless system access by the computing device 1000. The secure element 1024 can include an eUICC 108 on which to store one or more eSIMs 208, one or more UICCs 118 that store SIM or eSIM credentials (profiles), and/or a processor and/or chip component in a system on chip (SoC) module that stores iSIM credentials (profiles).

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

Cellular wireless access credentials to provide access to cellular wireless services of a cellular wireless service provider can be installed in a wireless device in a variety of forms including but not limited to a universal integrated circuit card (UICC) storing a subscriber identity module (SIM), an embedded UICC (eUICC) storing an electronic SIM (eSIM), or in hardware, such as a processor of system on chip (SoC) module storing an integrated SIM (iSIM). The embodiments described herein can apply to all of these type of implementations. A UICC storing a SIM can also be referred to as a SIM card. A SIM, eSIM, or iSIM can also be referred to as a SIM profile, an eSIM profile, or an iSIM profile respectively, or simply as a profile.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for public land mobile network (PLMN) selection and/or subscriber identity module (SIM) selection, the method comprising:
by a wireless device:
detecting the wireless device is roaming in or likely to roam to a visited geographic region;
determining one or more local PLMNs based on PLMN characterized performance scores for one or more PLMNs in the visited geographic region;
presenting, via a display of the wireless device, a recommendation for installation and/or selection of one or more local SIMs for the one or more local PLMNs; and
configuring the wireless device to use a local SIM of the one or more local SIMs while roaming, responsive to selection of the local SIM.

2. The method of claim 1 further comprising:
by the wireless device:
installing the local SIM in the wireless device, responsive to selection of the local SIM.

3. The method of claim 1 further comprising:
by the wireless device:
when no selection of a local SIM of the one or more local SIMs is obtained:
determining a best home PLMN and local roaming PLMN pair for roaming by the wireless device; and
configuring the wireless device to use a SIM associated with the local roaming PLMN while roaming.

4. The method of claim 1, wherein the PLMN characterized performance scores comprise one or more of: i) a data transfer score, ii) a latency score, iii) a video calling score, iv) a voice telephony score, v) a network access score, or vi) a network configuration score.

5. The method of claim 1, wherein:
determination of the one or more local PLMNs is further based on habitual device usage classification for the wireless device; and
the habitual device usage classification for the wireless device comprises one or more of:
i) a data intensive activity metric, ii) a latency critical activity metric, iii) a video calling activity metric, iv) a cellular voice activity metric, v) a burst connection activity metric, or vi) a low power mode metric.

6. The method of claim 1, wherein:
determination of the one or more local PLMNs is further based on habitual device usage classification for the wireless device; and
determination of the one or more local PLMNs comprises computing, for each PLMN of the one or more PLMNs in the visited geographic region, a similarity metric that compares a PLMN vector of the PLMN characterized performance scores for the corresponding PLMN to a device vector of the habitual device usage classification for the wireless device.

7. The method of claim 1, further comprising:
by the wireless device:
registering with a performance service server for notification of updates to the PLMN characterized performance scores; and
obtaining, from the performance service server, updates to the PLMN characterized performance scores,
wherein determination of the one or more local PLMNs is further based on the updates to the PLMN characterized performance scores.

8. The method of claim 1, wherein the PLMN characterized performance scores are obtained by the wireless device from a performance service server that agglomerates crowd-sourced performance metrics for PLMNs from multiple wireless devices.

9. The method of claim 1, further comprising:
by the wireless device:
determining a requirement for displaying a travel tip regarding use of SIMs while roaming; and
presenting, via the display of the wireless device, the travel tip in conjunction with display of the recommendation for installation and/or selection of one or more local SIMs for the one or more local PLMNs.

10. A method for public land mobile network (PLMN) selection, the method comprising:
by a wireless device:
detecting the wireless device is roaming in a visited geographic region;
determining a best local PLMN for the visited geographic region based on PLMN characterized performance scores for one or more available PLMNs; and
configuring the wireless device to use a SIM associated with the best local PLMN while roaming in the visited geographic region.

11. The method of claim 10, wherein the PLMN characterized performance scores comprise one or more of: i) a data transfer score, ii) a latency score, iii) a video calling score, iv) a voice telephony score, v) a network access score, or vi) a network configuration score.

12. The method of claim 10, wherein:
determination of the best local PLMN is further based on habitual device usage classification for the wireless device; and
the habitual device usage classification for the wireless device comprises one or more of:
i) a data intensive activity metric, ii) a latency critical activity metric, iii) a video calling activity metric, iv) a cellular voice activity metric, v) a burst connection activity metric, or vi) a low power mode metric.

13. The method of claim 10, wherein:
determination of the best local PLMN is further based on habitual device usage classification for the wireless device; and
determination of the best local PLMN comprises computing, for each PLMN of the one or more available PLMNs, a similarity metric that compares a PLMN vector of the PLMN characterized performance scores for the corresponding PLMN to a device vector of the habitual device usage classification for the wireless device.

14. The method of claim 10, further comprising:
by the wireless device:
registering with a performance service server for notification of updates to the PLMN characterized performance scores; and
obtaining, from the performance service server, updates to the PLMN characterized performance scores,
wherein determination of the best local PLMN is further based on updates to the PLMN characterized performance scores.

15. The method of claim 10, wherein the PLMN characterized performance scores are obtained by the wireless device from a performance service server that agglomerates crowd-sourced performance metrics for PLMNs from multiple wireless devices.

16. A method for public land mobile network (PLMN) selection and subscriber identity module (SIM) selection, the method comprising:
by a wireless device:
detecting the wireless device requires selection of a SIM, from multiple SIMs installed in the wireless device, for configuration of the wireless device;
determining, for each SIM of the multiple SIMs, a highest rated PLMN based on PLMN characterized performance scores for one or more PLMNs associated with the multiple SIMs; and
configuring the wireless device to use a SIM, of the multiple SIMs, having a best rated PLMN selected from among the highest rated PLMNs.

17. The method of claim 16, wherein:
determination of the highest rated PLMN is further based on habitual device usage classification for the wireless device; and
the habitual device usage classification for the wireless device comprises one or more of:
i) a data intensive activity metric, ii) a latency critical activity metric, iii) a video calling activity metric, iv) a cellular voice activity metric, v) a burst connection activity metric, or vi) a low power mode metric.

18. The method of claim 16, wherein:
determination of the highest rated PLMN is further based on habitual device usage classification for the wireless device; and
determination of the highest rated PLMN comprises computing, for each PLMN of the one or more PLMNs associated with the multiple SIMs, a similarity metric that compares a PLMN vector of the PLMN characterized performance scores for the corresponding PLMN to a device vector of the habitual device usage classification for the wireless device.

19. The method of claim 16, further comprising:
by the wireless device:
registering with a performance service server for notification of updates to the PLMN characterized performance scores; and
obtaining, from the performance service server, updates to the PLMN characterized performance scores,
wherein determination of the highest rated PLMN is further based on the updates to the PLMN characterized performance scores.

20. The method of claim 16, wherein the PLMN characterized performance scores are obtained by the wireless device from a performance service server that agglomerates crowd-sourced performance metrics for PLMNs from multiple wireless devices.
